(19) United States
(12) Patent Application Publication
(10) Pub. No.: US 2016/0108505 A1
(43) Pub. Date: Apr. 21, 2016

(54) METHOD FOR PRODUCING STARTING MATERIAL FOR CUTTING

(71) Applicant: SHOWA DENKO K.K., Tokyo (JP)

(72) Inventors: Takafumi FUJII, Kitakata-shi (JP); Yasuo OKAMOTO, Kitakata-shi (JP)

(73) Assignee: SHOWA DENKO K.K., Minato-ku,Tokyo (JP)

(21) Appl. No.: 14/895,526

(22) PCT Filed: Jul. 1, 2014
(86) PCT No.: PCT/JP2014/067500

§ 371 Date: Dec. 3, 2015

(30) Foreign Application Priority Data
Jul. 4, 2013 (JP) 2013-140766

(51) Int. Cl. C22F 1/057; C22C 21/14; B23P 15/02; C22C 21/18; C21D 1/60; C22F 1/00; C22C 21/16

(52) U.S. Cl. CPC C22F 1/057; C22F 1/002; C22C 21/14; C22C 21/16; C22C 21/18; C21D 1/60; B23P 15/02

(57) ABSTRACT

A method for producing a starting material for cutting capable of sufficiently eliminating residual stress is provided. The present invention is for producing a starting material for cutting which is a starting material for cutting to be cut/machined into a cut/machined product. The present invention includes a step for obtaining a primary molded article (1) by subjecting a molding material to primary forming, a step for subjecting the primary molded article (1) to a solution treatment and then quenching processing, and a step for subjecting the primary molded article (1) to secondary forming by cold forging after performing the quenching treatment, and obtaining a secondary molded article (2) as a starting material for cutting. The shape of the primary molded article (1) is determined in a manner as to eliminate the residual stress accumulating in the primary molded article (1) by the secondary forming.

### FIELD OF THE INVENTION

The present invention relates to a method for producing a starting material for cutting which is a shaped article to be cut into a cut/machined product and its related technologies.

### TECHNICAL BACKGROUND

A compressor impeller in a turbocharger for feeding a compressed air to an internal-combustion engine is produced by, for example, cutting/machining. Conventionally, when producing a starting material for cutting to be cut into a cut/machined product such as a compressor impeller, for example, a method prescribed in JIS T6511 is often used.

In this method, after performing a solution treatment of a workpiece as an extruded material, a quenching treatment is performed. Further, after performing cold drawing of the workpiece after the quenching treatment, an aging treatment is performed. Next, the workpiece subjected to the aging treatment is cut in accordance with the final product to obtain a starting material for cutting. Then, the starting material for cutting is subjected to cutting to produce a cut/machined product such as a compressor impeller, etc.

In this conventional method for producing a starting material for cutting, the residual stress (deformation) that accumulates at the time of quenching during a T6 treatment is eliminated by cold drawing. That is, in the drawing process, by drawing a workpiece through a diameter smaller than the diameter (extrusion diameter) of a workpiece before being drawn, permanent strain is applied to the workpiece to eliminate the residual stress to thereby improve the dimensional accuracy and the strength.

### PRIOR ART DOCUMENTS

### Non-Patent Documents

[Non-Patent Document 1] Japanese Standards Association Edition “JIS Handbook (3) Non-ferrous”, published by Japanese Standards Association Foundation, p. 1288.

### SUMMARY OF THE INVENTION

### Problems to be Solved by the Invention

However, in the cold drawing in the aforementioned conventional method for producing a starting material for cutting, since only the surface layer part of the workpiece is subjected to plastic flow, there are cases in which the residual stress (deformation) inside the workpiece cannot be sufficiently eliminated. When cutting is performed in a state in which the residual stress remains inside the starting material for cutting as mentioned above, the residual stress is released when the cutting is performed, which could become a cause of decrease in the dimensional accuracy of the cut/machined product.

The present invention was made in view of the aforementioned problems, and aims to provide a method for producing a starting material for cutting and its related technologies, capable of sufficiently eliminating the residual stress of a starting material for cutting, and preventing occurrence of problems such as a dimensional change, etc., after the cutting.

Other objects and advantages of the present invention will be apparent from the following preferred embodiments.

### Means for Solving the Problems

The present invention has the following configuration to achieve the aforementioned objects.

[1] A method for producing a starting material for cutting for producing a starting material for cutting to be cut into a cut/machined product, comprising:

a step for obtaining a primary molded article by subjecting a molding material to primary forming;

a step for subjecting the primary molded article to a solution treatment and then to a quenching treatment; and

a step for subjecting the primary molded article to secondary forming by cold forging after performing the quenching treatment to obtain a secondary molded article as a starting material for cutting,

wherein a shape of the primary molded article is determined in a manner as to eliminate residual stress accumulated in the primary molded article by the secondary forming.

[2] The method for producing the starting material for cutting as recited in the aforementioned item [1], wherein, in the secondary forming, a processing rate of the primary molded article to the secondary molded article is set to be 2% to 5%.

[3] The method for producing the starting material for cutting as recited in the aforementioned items [1] or [2], wherein cold forging is used for the primary forming.

[4] The method for producing the starting material for cutting as recited in the aforementioned items [1] or [2], wherein hot forging is used for the primary forming.

[5] The method for producing the starting material for cutting as recited in any one of the aforementioned items [1] to [4], wherein the secondary molded article includes a first part and a second part arranged in an axial direction and having different dimensions in a radial direction orthogonal to the axial direction, and wherein upset forging to compress in the axial direction is used as the secondary forming.

[6] The method for producing the starting material for cutting as recited in any one of the aforementioned items [1] to [5], wherein a shape of the secondary molded article is shaped so as to be capable of forming a compressor impeller having a hub and a plurality of blades formed radially on an outer peripheral surface of the hub by cutting.

[7] The method for producing a cut/machined product, comprising:

a step for obtaining a starting material for cutting by the method for producing as recited in any one of the aforementioned items [1] to [6]; and

a step for obtaining a cut/machined product by cutting the starting material for cutting.

[8] The method for producing the cut/machined product as recited in the aforementioned [7], wherein a compressor impeller having a hub and a plurality of blades formed radially on the outer peripheral surface of the hub is obtained as a cut/machined product.

[9] The method for producing the cut/machined product as recited in the aforementioned item [8], wherein, in the compressor impeller, an amount of positional displacement of a central axis between a top face and a bottom face is set to 0.01 mm or less.

[10] The method for producing the cut/machined product as recited in the aforementioned item [8] or [9], wherein, in the compressor impeller, a ratio of the amount of positional displacement of a central axis between a top face and a bottom face with respect to a diameter of the bottom face is set to 0.013% or lower.

[11] A starting material for cutting produced by the method for producing as recited in any one of the aforementioned items [1] to [6].

### Effects of the Invention

In the method for producing a starting material for cutting according to the invention as recited in the aforementioned item [1], since the primary molded article is subjected to plastic flow with cold forging, which is a secondary forming, a secondary molded article in which the residual stress is eliminated can be obtained as a starting material for cutting. In this starting material for cutting, since the residual stress is eliminated, when a cut/machined product is produced by cutting, the dimensional change after the cutting due to the residual stress can be assuredly prevented. Therefore, a high-accuracy and high-quality cut/machined product can be obtained.

In the method for producing a starting material for cutting according to the inventions as recited in the aforementioned Items [2] to [6], the aforementioned effects can be more assuredly obtained.

According to the inventions as recited in the aforementioned Items [7] to [10], a method for producing a cut/machined product exerting similar effects in a similar way as described above can be provided.

According to the invention as recited in the aforementioned Item [11], a starting material for cutting capable of producing a high-accuracy and high-quality cut/machined product can be provided by cutting.

### BRIEF DESCRIPTION OF THE DRAWINGS

FIG. 1 is a block diagram showing a production procedure of a method for producing a cut/machined product according to an embodiment of the present invention.

FIG. 2A is a perspective view of a cut article produced by the production method according to the embodiment.

FIG. 2B is a side view of a primary molded article produced by the production method according to the embodiment.

FIG. 2C is a side view of a secondary molded article produced by the production method according to the embodiment.

FIG. 2D is a perspective view of a cut/machined product produced by the production method according to the embodiment.

FIG. 3A is a cross-sectional view of a primary molded article produced by the production method according to an example related to the present invention.

FIG. 3B is a cross-sectional view of the primary molded article produced by the production method according to the example.

FIG. 3C is a cross-sectional view of a first cut/machined product produced by the production method according to an example.

FIG. 3D is a cross-sectional view of a second cut/machined product produced by the production method according to an example.

FIG. 4 is a block diagram showing a production procedure of a method for producing a cut/machined product according to a comparative example.

FIG. 5A is a cross-sectional view of a cut article produced by the production method according to the comparative example.

FIG. 5B is a cross-sectional view of a starting material for cutting produced by the production method according to the comparative example.

FIG. 5C is a cross-sectional view of a first cut/machined product produced by the production method according to the comparative example.

FIG. 5D is a cross-sectional view of a second cut/machined product produced by the production method according to the comparative example.

### EMBODIMENTS FOR CARRYING OUT THE INVENTION

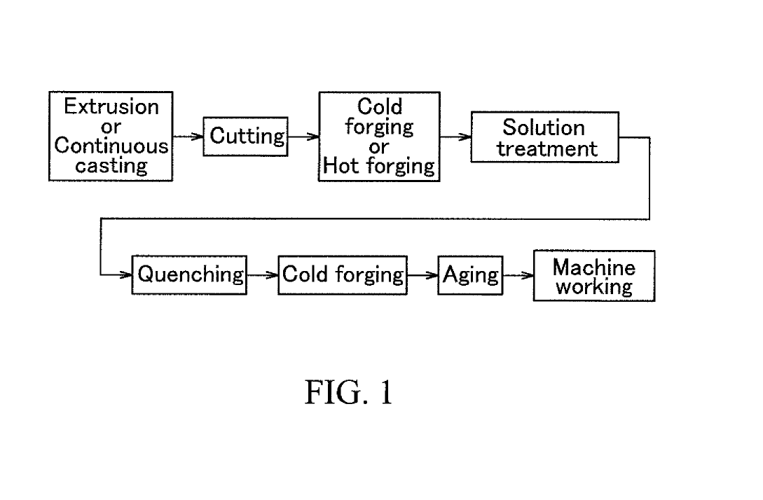

FIG. 1 is a block diagram showing a production procedure of a method for producing a cut/machined product according to an embodiment of the present invention. As shown in the figure, the production method of this embodiment is for obtaining a cut/machined product by producing a starting material for cutting by primarily utilizing a forging process and then subjecting the starting material for cutting to a cutting process. The cut/machined product 5 to be produced using the production method of this embodiment constitutes a compressor impeller of a turbocharger for feeding a compressed air to an internal-combustion engine.

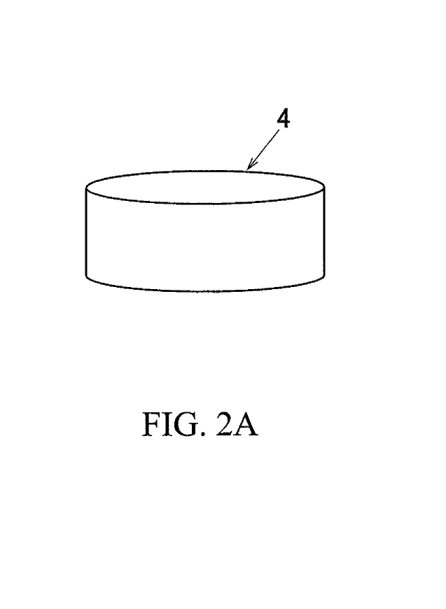

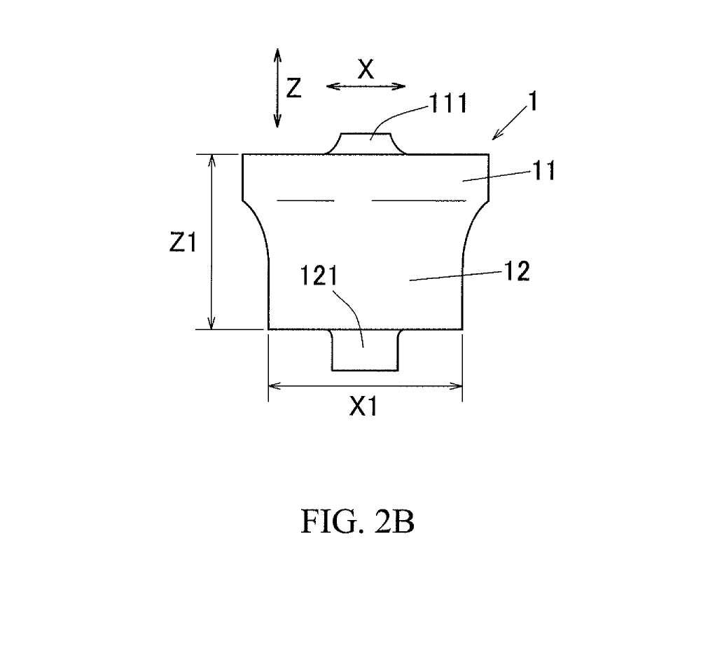

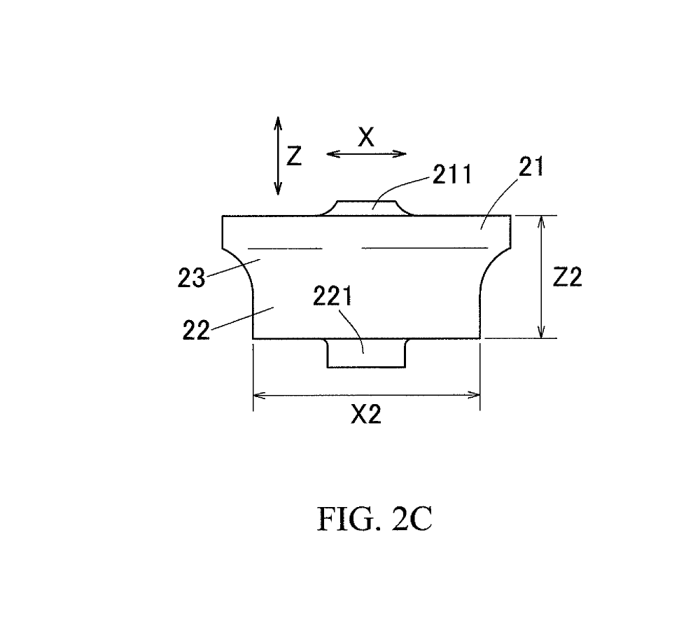

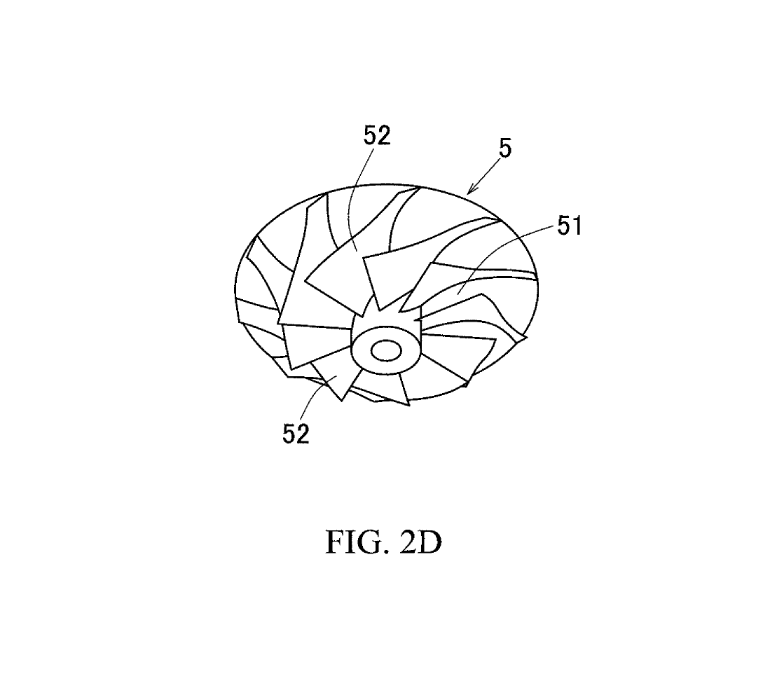

As shown in FIG. 2D, the compressor impeller as a cut/machined product 5 is equipped with a hub 51 of an approximately cone shape and a plurality of thin blades (wing parts) 52 formed radially on the outer peripheral surface of the hub 51.

In the production method of this embodiment, initially, as shown in FIG. 1, an extruded material or a cast material (cast bar) made of aluminum or its alloy is obtained by an extrusion process or a casting process. Needless to say, this extruded material can be obtained by subjecting the cast bar to an extrusion process. In this embodiment, the extruded material or the cast material is a processing material.

As a method for obtaining a cast bar, a DC casting method, a hot-top casting method, a vertical continuous casting method, a horizontal continuous casting method, a powder compacting method, etc., can be exemplified.

In the present invention, a continuously cast bar (diameter: 180 mm to 220 mm) is produced by continuous casting in which almost all of the structure is made of columnar crystals and/or granular crystals and the irregularities in the crystal grain size are unified. Further, in the present invention, an extruded material (diameter: 25 mm to 95 mm) obtained by subjecting the cast bar to an extrusion process is preferably used as a processing material. Alternatively, a continuously cast bar having a small diameter (diameter: 30 mm to 90 mm) is produced by continuous casting in which almost all of the structure is made of columnar crystals and/or granular crystals and the irregularities in the crystal grain size are unified. In the present invention, it is preferable to use this cast bar as a processing material. That is, in the former extruded material, the internal quality is suited for obtaining the effects of the present invention. Furthermore, in the latter continuously cast bar having a small diameter, the internal quality has sufficient cooling effects in view of the cooling rate, and the quality is suited for obtaining the effects of the present invention.

Next, the extruded material or the cast material as a processing material is cut according to the weight corresponding to the starting material for cutting which is a secondary molded article to be explained later to thereby obtain a cut article 4.

As shown in FIG. 2A, in this embodiment, the cut article 4 has a columnar shape which is short in the axial direction. In this embodiment, a molding material is constituted by the cut article 4.

Next, the cut article 4 is subjected to cold closed-die forging or hot closed-die forging to obtain a primary molded article 1. Although the detailed shape of the primary molded article 1 will be detailed later, as shown in FIG. 2B, schematically, the primary molded article 1 is equipped with a discoidal or cylindrical large-diameter part 11 and a cylindrical small-diameter part 12 formed on one end face of the large-diameter part 11, and the large-diameter part 11 and the small-diameter part 12 are integrally formed in a state in which the axial centers are aligned. The large-diameter part 11 is formed so that the dimension in the radial direction X (dimension of the diameter) is formed to be larger than the small-diameter part 12, and an adjacent part to the large-diameter part 11 on the outer peripheral surface of the small-diameter part 12 is formed into a curved surface 13[yk1] having a smooth concave spherical shape. Furthermore, a convex part 111 is formed at the axial center position on the other end face of the large-diameter part 11, and a convex part 121 is formed at the axial center position on one end face of the small-diameter part 12. In this embodiment, the small-diameter part 12 of the primary molded article 1 is configured as a blade forming part.

Further, in this embodiment, the large-diameter part 11 constitutes either one of the first and second parts, and the small-diameter part 12 constitutes the remaining part.

In this embodiment, either cold forging or hot forging can be used as the primary forming (1F). For example, in the case of producing a small-sized product, cold forging, which is capable of processing with high accuracy, is suited. In the case of producing a large-sized article, hot forging, which is easier for processing a large-sized product, is suited, since the deformation resistance inside the material decreases from the heating.

In the present invention, the primary forming can be a forming method other than forging, such as, for example, casting or machining. In the present invention, however, considering the productivity, a forging process such as the aforementioned cold forging or hot forging, etc., is preferably used.

After performing the primary forming as shown in FIG. 1, the primary molded article 1 is subjected to a solution treatment. For the conditions of the solution treatment, for example, the temperature is set to 490° C. to 540° C. and the time is set to 0.5 hours to 6 hours.

After performing the solution treatment, the primary molded article 1 is subjected to a quenching treatment. In the quenching treatment, for example, the primary molded article 1 is immersed in water.

After the quenching, the primary molded article 1 is subjected to a secondary forming (2F) to obtain a secondary molded article 2[yk2]. In this embodiment, as shown in FIG. 1, a cold closed-die forging such as cold heading using a mold, etc., is used.

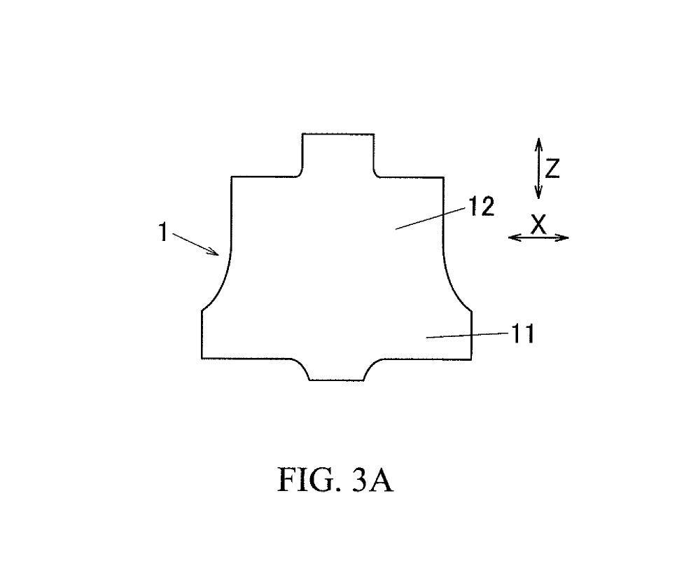

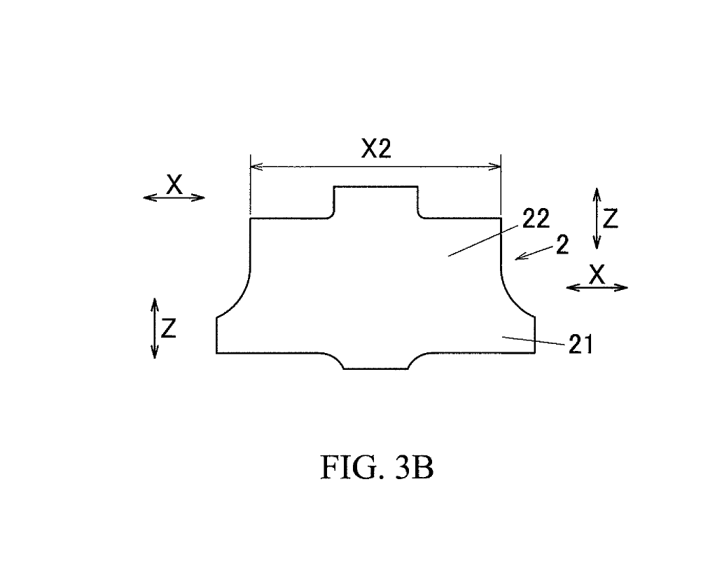

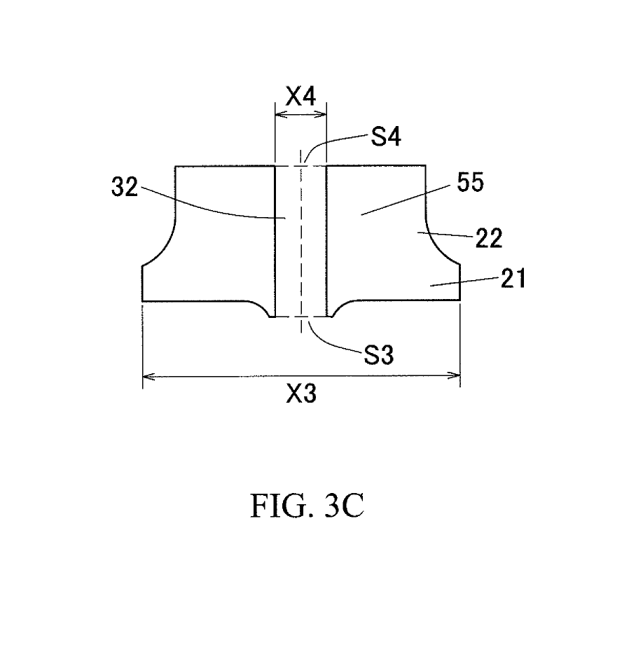

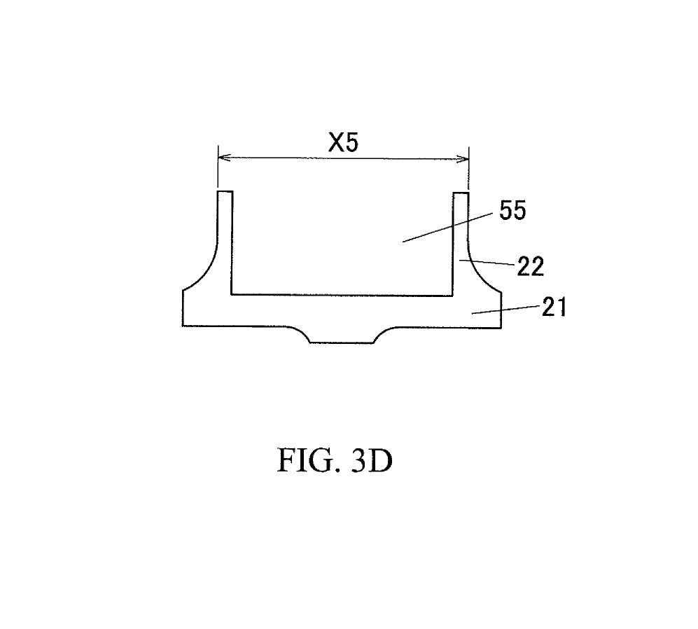

As shown in FIG. 2C, the secondary molded article 2 is formed into an approximately similar shape as the primary molded article 1, although the dimension of each part is slightly different. In fact, although the differences of the outer appearances between the primary molded article 1 and the secondary molded article 2 are hardly recognized, in this embodiment, the differences of the outer appearances between the primary molded article 1 shown in FIG. 2B and the secondary molded article 2 shown in FIG. 2C are shown in an exaggerated manner to make the present invention easier to understand (same for FIG. 3A and FIG. 3B).

The secondary molded article 2, in the same manner as the primary molded article 1, is equipped with a discoidal or cylindrical large-diameter part 21 and a cylindrical small-diameter part 22 formed on one end face of the large-diameter part 21, and the large-diameter part 21 and the small-diameter part 22 are integrally formed in a state in which the axial centers are aligned. In the large-diameter part 21, the dimension (dimension of the diameter) is formed to be larger in the radial direction X of the small-diameter part 22, and on the outer peripheral surface of the small-diameter part 22, the adjacent part to the large-diameter part 21 is formed into a curved surface 23 having a smooth concave spherical shape. Furthermore, a convex part 211 is formed at the axial center position on the other end face of the large-diameter part 21, and a convex part 221 is formed at the axial center position on one end face of the small-diameter part 22. Furthermore, in this embodiment, the small-diameter part 22 of the secondary molded article 2 is configured as a blade forming part.

Further, in this embodiment, the large-diameter part 21 constitutes either one of the first and second parts, and the small-diameter part 22 constitutes the remaining part.

In this embodiment, the secondary molded article 2 obtained by this secondary forming is formed into a shape before the cut/machined product 5, as a final article such as a compressor impeller, etc., is subjected to a cutting process. For example, this secondary molded article 2 is formed into a shape corresponding to a shape of a workpiece to be set in a device for performing the cutting process, which is the final processing. Therefore, in order to effectively perform the cutting process with high accuracy, the accuracy of the secondary molded article 2 needs to be improved.

In the meantime, when the primary molded article 1 is subjected to a quenching treatment before performing the secondary forming, the volume of the primary molded article 1 temporarily decreases due to thermal contraction. Further, along with the thermal contraction, deformation as tensile stress (residual stress) accumulates inside the primary molded article 1. In a state in which the residual stress remains, when mechanical processing such as cutting, etc., is performed in a later process, the residual stress is released by the processing, causing a slight deformation of the product, which in some cases makes it difficult to maintain high dimensional accuracy.

Therefore, in this embodiment, the residual stress accumulated at the time of quenching is eliminated by the secondary forming.

In the secondary forming of this embodiment, by subjecting the primary molded article 1 after the quenching to forging at a predetermined processing rate, a moderate amount of permanent deformation is applied to the entire inner part of the primary molded article 1 to eliminate the residual stress.

Therefore, in this embodiment, although the secondary molded article 2 is formed based on the shape of the cut/machined product 5 as a final product, in the primary molded article 1, it is formed into a shape that the deformation caused at the time of quenching of the primary molded article 1 can be eliminated by the secondary forming. For example, a value (processing rate) that the residual stress caused at the time of quenching of the primary molded article 1 can be eliminated is calculated in advance as the processing rate at the time of subjecting the primary molded article 1 to the secondary forming, and the shape of the primary molded article by the primary forming is determined based on the processing rate.

In the meantime, in the case of eliminating the residual stress by a drawing process in a conventional manner, since permanent deformation is applied only to the surface layer part of the workpiece, it is difficult to eliminate the residual stress from the entire inner part of the workpiece. On the other hand, in this embodiment, since the entire area of the primary molded article 1 is plastically flowed by forging, the residual stress in the entire inner part of the primary molded article 1 can be effectively eliminated, which can assuredly avoid adverse effects due to the residual stress.

Here, in this embodiment, as shown in FIG. 2B and FIG. 2C, when the axial direction of each of the molded articles 1 and 2 is defined as a Z direction, the direction (radial direction) that is orthogonal to the Z direction (axial direction) is defined as an X direction, the dimension of the primary molded article 1 in the Z direction (axial direction dimension) is defined as “Z1”, the dimension of the small-diameter part 11 in the X direction (radial dimension) is defined as “X1”, the dimension of the secondary molded article 2 in the Z direction (axial direction dimension) is defined as “Z2”, and the dimension of the small-diameter part 12 in the X direction (radial dimension) is defined as “X2”, the processing rate (Rx) of the small-diameter part 12 in the X direction (radial direction) and the processing rate (Rz) of the small-diameter part 12 in the Z direction (axial direction) of the small-diameter part 12 can be calculated by the following equation.

Rx=|(X1−X2)|/X2|×100[%]

Rz=|(Z1−Z2)|/Z2|×100[%]

In this embodiment, these processing rates are preferably set to 2% to 5%, more preferably 2.5% to 3.5%. That is, when the processing rate is too low, sufficient permanent deformation cannot be applied to the workpiece in the secondary processing, which may make it difficult to sufficiently eliminate the residual stress. On the other hand, when the processing rate is too high, the degree of deformation becomes too large, causing accumulation of the residual stress, which may cause deterioration of the dimensional accuracy. This processing rate corresponds to the ratio (%) of the applied quantity of permanent deformation in the following example.

As for the large-diameter part 11 and 21 and other parts, the processing rate can be calculated by a method similar to the aforementioned processing rate calculation method.

In the meantime, in this embodiment, since upsetting is employed as the secondary forming, the primary molded article 1 is formed so as to be compressed in the axial direction Z and expanded in the radial direction X by the upsetting. On the other hand, since the residual stress caused from the compression at the time of quenching becomes tensile stress toward the inside of the primary molded article 1, when the primary molded article 1 is subjected to upsetting as a secondary forming, even though the residual stress in the radial direction X can be effectively eliminated, it is difficult to eliminate the residual stress in the axial direction Z. Rather, there is a possibility to cause possible accumulation of the residual stress in the axial direction Z.

However, in this embodiment, as for the compressor impeller produced as the cut/machined product 5 as a final product, high dimensional accuracy is required for the blades 52 that function as main parts, but not so high dimensional accuracy is required in the axial direction Z in comparison to the dimensional accuracy of the blades 52. Since the blades 52 of the compressor impeller are formed radially on the outer peripheral surface of the hub 51, in the secondary molded article 2 before cutting, it is important to eliminate the residual stress in the radial direction X, which affects the shape of the blades 52. Further, it is considered that there are almost no adverse effects even if there remains residual stress in the axial direction Z.

Therefore, since upsetting is employed as the secondary forming in this embodiment, the residual stress in the radial direction X can be assuredly eliminated by the upsetting, and it is possible to assuredly obtain a compressor impeller that is highly accurate and is high in quality as a cut/machined product 5.

In addition, in a case in which forging dies for the primary forming and the secondary forming are actually produced when employing the production method of this embodiment, it is necessary to consider the elongation rate specific to the materials to be used.

For example, when using cold forging as primary forming, it is necessary to consider the extension scale (0 to 1/1,000 mm) of the material due to the recovery phenomenon of the material at the time of secondary forming (at the time of cold forging).

Specifically, the following relational expression holds when the radial direction dimension of the primary forming die is “DX1 (mm)”, the radial direction dimension of the secondary forming die is “DX2 (mm)”, and the processing dimension calculated from the processing rate (processing rate required for removal of deformation) in the secondary forming of the primary molded article 1, that is, the amount of permanent deformation (mm) to be applied is “ΔXa”, and the extension scale (mm) of the material due to the recovery phenomenon of a material at the time of secondary forming (at the time of upsetting) is “ΔXb”.

DX1=DX2−ΔXa+ΔXb

Then, based on this equation, the size of the secondary forming die (DX2, etc.) is calculated from the final product (cut/machined product 5), and from that size, the size of the primary forming die (DX1) is calculated.

Further, when employing hot forging as the primary forming, it is also necessary to consider the extension scale ( 4/1,000 mm to 5/1,000 mm) of the material at the time of the primary forming (at the time of the hot forging).

That is, the following relational expression holds when the extension scale of the material at the time of the primary forming (at the time of hot forging) is “ΔXc (mm)”.

DX1=DX2−ΔXa+ΔXb−ΔXc

Therefore, the primary forming die is designed based on this equation in the same manner as mentioned above.

As shown in FIG. 1, in this embodiment, after performing upsetting as the secondary forming, the secondary molded article 2 is subjected to an aging treatment. For the conditions for the aging treatment, for example, the temperature is set to 160° C. to 220° C. and the time is set to 0.5 hours to 24 hours.

After performing the aging treatment, the secondary molded article (starting material for cutting) 2 is subjected to a cutting process to produce a compressor impeller as a final product (cut/machined product 5) as shown in FIG. 2D.

As described above, according to the production method of the cut/machined product of this embodiment, after eliminating the residual stress, especially the residual stress in the radial direction X of the secondary molded article 2, by upset forging as the secondary forming, the secondary molded article 2 is subjected to a cutting process as a starting material for cutting to produce a cut/machined product 5 such as a compressor impeller. Therefore, deformation after the cutting process due to residual stress, especially dimensional changes of the blades 52, can be assuredly prevented, which enables obtaining a cut/machined product 5 such as a high-accuracy and high-quality compressor impeller having blades 52 excellent in dimensional accuracy.

Further, in the starting material for cutting obtained by this embodiment, since the production steps include a forging step, “cavities (blow-holes)” generated during the casting can be reduced in the forging step, which enables obtaining a cut/machined product 5 having high dimensional accuracy. That is, especially in a cut/machined product 5 such as a compressor impeller, a part that is required to have high dimensional accuracy and a part where the degree of plastic working is large for removing deformation are the same part. Therefore, as a result, in the part that is required to have high dimensional accuracy, since the “cavities (blow-holes)” that occur during the casting and become defects during the cutting process are reduced in the forging step, a cut/machined product 5 having high dimensional accuracy can be obtained.

Further, in the aforementioned embodiment, although a compressor impeller was exemplified as a cut/machined product 5 to be produced, the present invention is not limited to that. The present invention can also be applied when producing cut/machined products for an electric scroll which is a compressor member of an automobile air conditioner, an engine piston, etc.

### EXAMPLES

Hereinafter, examples relating to the present invention will be explained.

### Example 1

An alloy material consisting of alloy number 2618 Al—Cu series alloy (Si: 0.15 to 0.28 mass %, Fe: 0.0 to 1.4 mass %, Cu: 1.8 to 2.7 mass %, Mn: 0.25 mass % or less, Mg: 1.2 to 1.8 mass %, Cr: 0.05 mass % or less, Ni: 0.9 to 1.4 mass %, Zn: 0.15 mass % or less, Ti: 0.2 mass % or less, Ti+Zr: 0.25 mass % or less[yk3]) was prepared.

The alloy material was subjected to casting to obtain a cast bar, and the cast bar was subjected to extrusion to obtain an extruded material. Furthermore, the extruded material was cut into a predetermined length to produce a cylindrical cut article 4 as shown in FIG. 2A. Further, the mass of the cut article 4 was adjusted so as to have the same mass as the secondary molded article 2 as a starting material for cutting to be explained later.

Next, the cut article 4 was subjected to cold closed-die forging as described in detail in the aforementioned embodiment to obtain a primary molded article 1 as an intermediate article of a compressor impeller as shown in FIG. 3A.

Next, after the primary molded article 1 was subjected to a solution treatment under the condition of a temperature of 535° C. for 3 hours, it was immersed in water to perform a quenching treatment.

The primary molded article 1 after the quenching was subjected to cold closed-die forging (upsetting) as secondary forming to obtain a secondary molded article 2. In this secondary forming, the ratio (processing rate) of the amount of permanent deformation to be applied (amount of permanent deformation to be applied) was set to 1%. That is, in the secondary forming, the primary molded article 1 was expanded in the radial direction and compressed in the axial direction by an amount corresponding to 1% of the size of the secondary molded article.

Further, the ratio of the applied amount of permanent deformation is a ratio based on the secondary molded article 2, similarly to the aforementioned processing rate. That is, a primary forming die and a secondary forming die were designed so that, when both the radial dimension and the axial dimension, for example, of the secondary molded article 2 were 100%, the radial dimension of the primary molded article 1 became 99% and the axial dimension became 101%, and the die was used.

Next, the secondary molded article 2 was subjected to an aging treatment under the condition of a temperature of 200° C. for 12 hours to obtain the starting material for cutting (secondary molded article 2) of Example 1.

### Example 2

In this secondary forming, the ratio of the amount of applied permanent deformation was set to 3%. That is, in the secondary forming, the primary molded article 1 was expanded in the radial direction and compressed in the axial direction by an amount corresponding to 3% of the size of the secondary molded article. Other than that, the starting material for cutting according to Example 2 was obtained in the same manner as in Example 1.

### Example 3

In the secondary forming, the ratio of the amount of permanent deformation to be applied was set to 5%. That is, in the secondary forming, the primary molded article 1 was expanded in the radial direction and compressed in the axial direction by the amount corresponding to 5% of the size of the secondary molded article. Other than that, the starting material for cutting according to Reference Example 1 was obtained in the same manner as in the aforementioned Example 1.

### Example 4

In the secondary forming, the ratio of the amount of permanent deformation to be applied was set to 10%. That is, in the secondary forming, the primary molded article 1 was expanded in the radial direction and compressed in the axial direction by an amount corresponding to 10% of the size of the secondary molded article. Other than that, the starting material for cutting according to Reference Example 2 was obtained in the same manner as in Example 1.

### Comparative Example 1

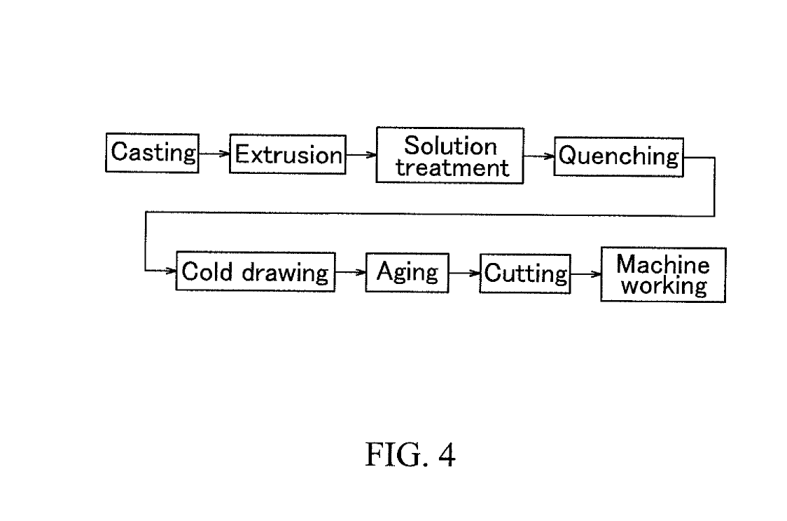

A starting material for cutting was produced by a procedure as shown in FIG. 4. That is, an alloy material which was the same as in Example 1 was subjected to casting to obtain a cast bar, and the cast bar was subjected to extrusion to obtain an extruded material.

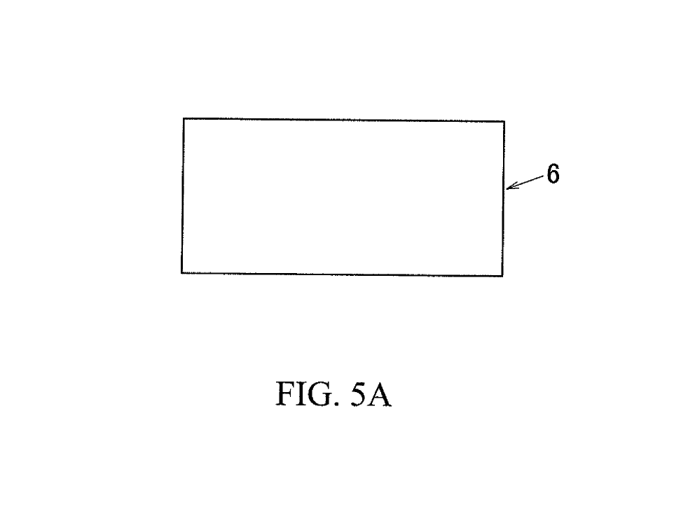

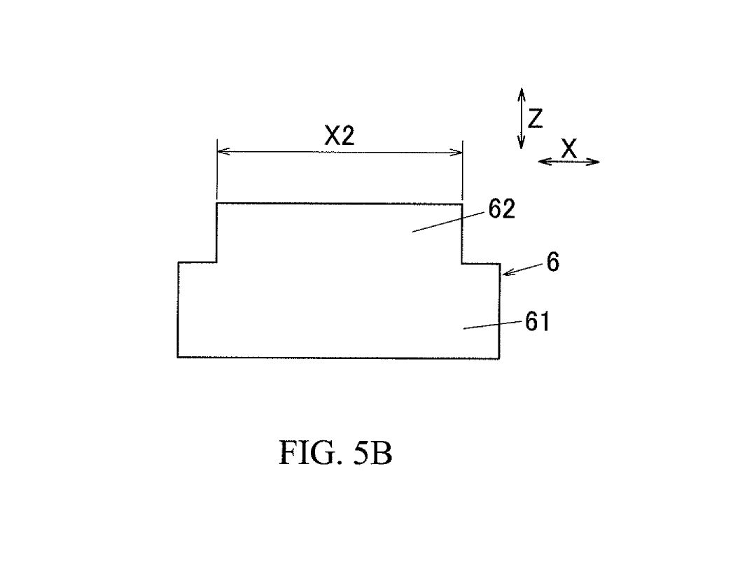

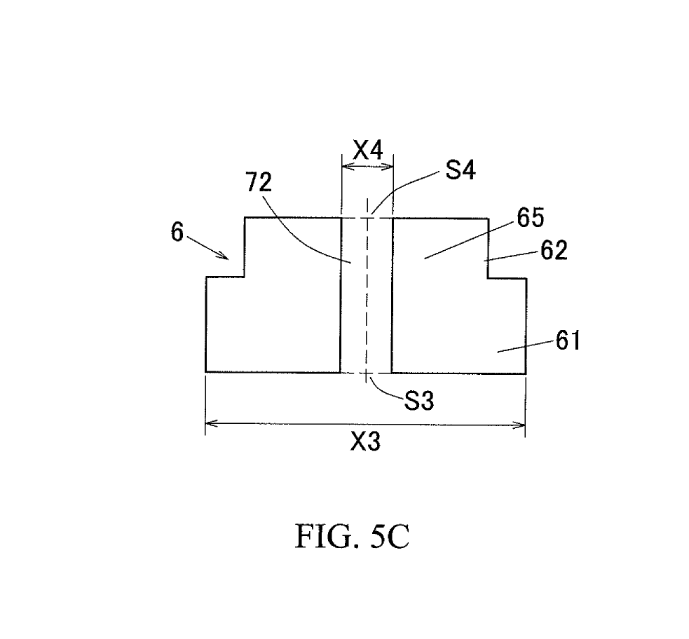

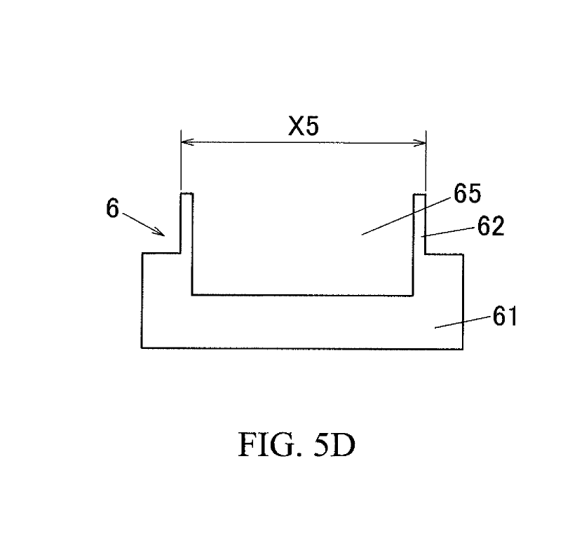

After subjecting the extruded material to a solution treatment and a quenching treatment under the same condition as in Example 1, cold drawing was performed to eliminate the residual stress. After that, after the drawn material was subjected to an aging treatment under the same condition as in Example 1, it was cut into a predetermined length to obtain a cylindrical cut article 6 as shown in FIG. 5A.

Next, as shown in FIG. 5B, the outer periphery of the upper side part of the cut article 6 was subjected to a cutting process, and the cut part was called the small-diameter part 62 and the part that was not cut was called the large-diameter part 61. With this, a starting material for cutting having an outer appearance shape close to the starting material for cutting of Example 1 was obtained.

Further, the diameters of the small-diameter part 62 and the large-diameter part 61 of the starting material for cutting of Comparative Example 1 were set to be the same sizes as the diameters of the small-diameter part 22 and the large-diameter part 21 of Example 1.

### <Test (1) Relating to Dimensional Change>

For each starting material for cutting according to Examples 1 to 4, among the diameters X3 of the bottom part (large-diameter part 21), the diameters X3 at three arbitrary positions were measured (see FIG. 3C). Similarly, for the starting material for cutting according to Comparative Example 1, among the diameters X3 of the bottom part (large-diameter part 61), the diameters X3 at three arbitrary positions were measured (see FIG. 5C). In these Examples and Comparative Example, the diameters at the aforementioned arbitrary three positions of the starting material for cutting were X31, X32, X33. The average value of the diameters X31 to X33 was 80 mm.

Next, as shown in FIG. 3C, each starting material for cutting of Examples 1 to 4 was subjected to a cutting process so as to penetrate the central portion with NC lathe processing from an end face of the bottom part (large-diameter part) 21 side to the end face of the small-diameter part 22 side. With this, a cylindrical through-hole part 32 was formed along the axial center of each starting material for cutting, and each of the cut/machined products (first cut/machined product) of Examples 1 to 4 was produced. Further, the through-hole part 32 is assumed to be an insertion hole for a rotational axis of a rotational body, for example, a rotational axis of a turbo impeller[yk4]. Furthermore, the average value of the diameter X4 of the through-hole part 32 was 6 mm.

As shown in FIG. 5C, a through-hole part 72 was formed in the starting material for cutting of Comparative Example 1 in the same manner as in the aforementioned Examples to produce the cut/machined product (first cut/machined product) of Comparative Example 1.

Next, for each cut/machined product according to Examples 1 to 4 and Comparative Example 1, the central position (xs3, ys3) of the bottom part side S3 of the through-hole part 32 was measured. Furthermore, the central position (xs4, ys4) of the upper surface part side S4 of the through-hole part 32 was measured on the same X-Y coordinate. For the central position, the contour shape of both sides S3 and S4 of the through-hole part 32 was each approximated as a perfect circle, and the central positions of the perfect circles were set to be the respective central positions. Then, the amount of deviation from the central position (xs3, ys3) to the central position (xs4, ys4) was calculated. That is, the distance between the central position (xs3, ys3) and the central position (xs4, ys4) was calculated, and the distance was called the deviation amount of the central axis (mm). The same evaluation was performed for each of 10 samples for each of Examples 1 to 4 and Comparative Example. Then the average value and the maximum value of the deviation amount of the central axis were calculated from these results. The results are shown in Table 1.

In Table 1, the “ratio” in the items “average” and “maximum value” is a ratio of each of the deviation amount of the central axis (mm) with respect to the diameter (80 mm) of the bottom part side (large-diameter part side). Furthermore, in the “evaluation” in the item “average”, indicates a case in which the amount of deviation is 0.008 or lower, “◯” indicates a case in which it exceeds 0.008 mm but equal to 0.009 mm or lower, “Δ” indicates a case in which it exceeds 0.009 mm but equal to 0.010 mm or lower, and “X” indicates a case in which it exceeds 0.010 mm. Furthermore, in the “evaluation” of the item “maximum value”, “⊚” indicates a case in which the amount of deviation is 0.015 mm or lower, “◯” indicates a case in which it exceeds 0.015 mm but equal to 0.025 mm or lower, and “X” indicates a case in which it exceeds 0.025 mm.

TABLE 1

| | Ratio of | Evaluation of coaxial degree | | | | | |
|---|---|---|---|---|---|---|---|
| | amount of | (deviation amount of central axis) | | | | | |
| | permanent | Average value | | | Maximum value | | |
| | deformation | | | Evalua- | | | Evalua- |
| | to be applied | (mm) | Ratio | tion | (mm) | Ratio | tion |
| Ex. 1 | 1% | 0.010 | 0.013% | Δ | 0.021 | 0.026% | ◯ |
| Ex. 2 | 3% | 0.008 | 0.010% | ⊚ | 0.013 | 0.016% | ⊚ |
| Ex. 3 | 5% | 0.009 | 0.011% | ◯ | 0.013 | 0.016% | ⊚ |
| Ex. 4 | 10% | 0.010 | 0.013% | Δ | 0.021 | 0.026% | ◯ |
| Com. | — | 0.012 | 0.015% | X | 0.026 | 0.033% | X |
| Ex. 1 | | | | | | | |

As it is apparent from Table 1, in the compressor impeller of the cut/machined products of Examples 1 to 4, the positional displacement of the central axis between the top surface and the bottom surface is small. On the other hand, in the compressor impeller of Comparative Example, the positional displacement of the central axis is large. Specifically, for Examples 2 and 3, the average value is 0.009 mm or less and the maximum value is 0.013 mm or less. Further, for Examples 1 and 4, the average value is 0.010 mm or less and the maximum value is 0.021 mm or less. For Comparative Example, the average value is 0.012 mm and the maximum value is 0.026 mm.

In such a compressor impeller of Examples relating to the present invention, since the positional displacement of the central axes is small, it is preferable in terms of the stability as a rotational body. Furthermore, since the amount of cutting process for aligning the central axis between the top and bottom faces can be reduced, it is preferable in terms of the cutting process.

In other words, in the present invention, the average value of the amount of positional displacement of the central axis between the top and bottom surfaces of the cut/machined product is preferably set to 0.01 mm or less, more preferably set to 0.009 mm or less. Furthermore, the ratio of the amount of the positional displacement (average value) to the diameter of the bottom face is preferably set to 0.013% or less, more preferably set to 0.0125% or less, even more preferably set to 0.011% or less.

Further, the maximum value of the amount of positional displacement is preferably set to 0.025 mm or less, more preferably set to 0.21 mm or less. Furthermore, the ratio of the amount of the positional displacement (maximum value) is preferably set to 0.032% or less, more preferably set to 0.026% or less, even more preferably set to 0.016% or less.

### <Test Relating to Dimensional Change (2)>

As shown in FIG. 3B and FIG. 5B, for each starting material for cutting according to the aforementioned Examples 1 to 4 and Comparative Example 1, among the diameter X2 of the small-diameter part 22, each of the diameters X2 at three arbitrary positions were measured. In these Examples, etc., the diameters at the aforementioned arbitrary three positions on the starting material for cutting are X21, X22, X23.

Next, each starting material for cutting of Examples 1 to 4 shown in FIG. 3B was subjected to a cutting process so as to bore the central portion with NC lathe processing from an end face (top face) on the small-diameter part 22 side as shown in FIG. 3D. With this, a cylindrical concave part 55 was formed in the small-diameter part 22 of each starting material for cutting, and each of the cut/machined products (second cut/machined product) of Examples 1 to 4 was produced. In the small-diameter part 22, the thickness of the remaining outer peripheral wall was adjusted to around 2 mm.

On the other hand, the starting material for cutting of Comparative Example 1 as shown in FIG. 5B was subjected to a cutting process to form a cylindrical concave part 65 in the small-diameter part 62 in the same manner as in the aforementioned Example 1, etc., as shown in FIG. 5D to produce the cut/machined product (second cut/machined product) of Comparative Example 1.

Next, for each cut/machined product according to the aforementioned Examples 1 to 4 and Comparative Example 1, among the diameter X5 of the small-diameter part 22 and 26 having a concave part 65, each of the diameters at three arbitrary positions were measured in a similar manner as above. In this Example, etc., the diameters at the aforementioned arbitrary three positions on the cutting article are X51, X52, X53.

Next, for each cut/machined product, the amount of dimensional change before cutting and after cutting, “|X21−X51|=ΔA1 (mm)”, “|X22−X52|=ΔA2 (mm)”, “|X23−X53|=ΔA3 (mm)” were measured for the diameters at the aforementioned three arbitrary positions, and further, the average value of each of the amount of dimensional change “(ΔA1+ΔA2+ΔA3)/3=ave. ΔA (mm)” was measured. The results are shown in Table 2.

TABLE 2

| | Ratio of amount | | | | |
|---|---|---|---|---|---|
| | of permanent | | | | |
| | deformation | ΔA1 | ΔA2 | ΔA3 | Ave. ΔA |
| | to be applied | (mm) | (mm) | (mm) | (mm) |
| Ex. 1 | 1% | 0.081 | 0.13 | 0.089 | 0.100 |
| Ex. 2 | 3% | 0.018 | 0.026 | 0.021 | 0.022 |
| Ex. 3 | 5% | 0.067 | 0.052 | 0.06 | 0.060 |
| Ex. 4 | 10% | 0.185 | 0.176 | 0.159 | 0.173 |
| Comp. | — | 0.1 | 0.085 | 0.088 | 0.019 |
| Ex. 1 | | | | | |

As it is apparent from Table 2, among Examples 1 to 4, especially for Examples 2 and 3, which have a ratio of the amount of applied permanent deformation of 3% and 5%, the amount of dimensional change ΔA was small, and a high-accuracy and high-quality cut/machined product was obtained. That is, in Examples 2 and 3, it is considered that since residual stress was sufficiently eliminated by the secondary forming for the starting material for cutting before cutting, a high-accuracy and high-quality cut/machined product was obtained.

Further, in Example 1 in which the ratio of the applied amount of permanent deformation was 1%, the amount of dimensional change ΔA was slightly larger in comparison to Example 2 and 3, but it was in a permissible range. In Example 1, it is considered that the reason for the increase in the amount of dimensional change ΔA was that there was slightly less plastic flow at the time of the secondary forming and residual stress remained slightly.

Further, in Example 4 in which the ratio of the applied amount of permanent deformation was 10%, the amount of dimensional change ΔA was slightly larger in comparison to Example 2 and 3, but it was in a permissible range. In Example 4, it is considered that the reason for the increase in the amount of dimensional change ΔA is that the plastic deformation at the time of the secondary forming was slightly large and residual stress accumulated slightly.

On the other hand, in Comparative Example 1 which was produced in conformity to the conventional method, it is considered that permanent deformation can be only applied to the surface layer part at the time of drawing, so residual stress was not sufficiently eliminated, which increased the amount of dimensional change ΔA.

Further, the ratio of the average value of the amount of dimensional change (ave. ΔA) and the average value of X21 to X23 which is the diameter measurement before cutting (60 mm), that is, the ratio of the amount of dimensional change before and after cutting with respect to the measurement before cutting can be expressed in (ave. ΔA)/60×100. This ratio is 0.17% in Example 1, 0.037% in Example 2, 0.1% in Example 3, and 0.29% in Example 4.

In other words, in the present invention, for the cut/machined product (compressor impeller), the ratio of the amount of the dimensional change before and after the cutting with respect to the measurement before cutting is preferably set to 0.03% to 0.5%, more preferably 0.035% to 0.30%. That is, when the ratio is satisfied, a cut/machined product having high dimensional accuracy can be obtained.

### Example 11

An alloy material consisting of an Al—Cu series alloy (Si: 0.3 to 0.7 mass %, Fe: 0.18 to 0.25 mass %, Cu: 3.3 to 3.9 mass %, Mn: 0.7 mass % to 1.1 mass % or less, Mg: 1.4 to 1.75 mass %, Cr: 0.1 mass % or less, Ni: 1.0 mass % or less, Zn: 0.1 mass % or less, Ti: 0.01 to 0.025 mass % or less, Al: the balance) was prepared.

A forging process was performed in the same manner as in the aforementioned Example 1 using this alloy material to obtain a primary molded article 1 (see FIG. 3A). After this primary molded article 1 was subjected to a solution treatment under the heat treatment condition of a temperature of 515° C. for 3 hours, it was immersed in water to perform a quenching treatment.

The primary molded article 1 after the quenching treatment was subjected to a forging process in the same manner as in Example 1 to obtain a secondary molded article 2 (see FIG. 3B). The secondary molded article 2 was subjected to an aging treatment under the heat treatment condition of a temperature of 190° C. for 10 hours to obtain a starting material for cutting of Example 11.

### Example 12

Except that the amount of applied permanent deformation was set to be the same as in the aforementioned Example 2, the starting material for cutting according to Example 12 was obtained in the same manner as in the aforementioned Example 11.

### Example 13

Except that the amount of applied permanent deformation was set to be the same as in the aforementioned Example 3, the starting material for cutting according to Example 13 was obtained in the same manner as in the aforementioned Example 11.

### Example 14

Except that the amount of applied permanent deformation was set to be the same as in the aforementioned Example 4, the starting material for cutting according to Example 14 was obtained in the same manner as in the aforementioned Example 11.

### <Test Relating to Dimensional Change>

Using the starting material for cutting according to Examples 11 to 14, tests (1) and (2) relating to the dimensional change were performed in the same manner as described above, and it was evaluated in the same manner. As a result, the same evaluations as in Examples 1 to 4 were obtained for Examples 11 to 14 (see Tables 1 and 2).

### Example 21 to 24

The same alloy material as in the aforementioned Example 1 was prepared. The alloy material was melted and the components were adjusted. Afterwards, using the alloy material, continuous casting was performed, in which almost all of the constitution is columnar crystals and/or granular crystals, and the irregularities in the grain size are unified, to obtain a cast bar having a diameter of 180 mm to 220 mm. Then, extrusion was performed using the cast bar to obtain an extruded material. Then the extruded material was cut to obtain a cut article (see FIG. 2A). Afterward, using the cut article, in the same manner as in the aforementioned Examples 1 to 4, the starting material for cutting (secondary molded article) was obtained (see FIG. 3B).

### Example 31 to 34

Except that the same alloy material as in the aforementioned Example 11 was prepared, the starting material for cutting (secondary molded article) of Examples 31 to 34 were obtained in the same manner as in the aforementioned Examples 21 to 24.

### <Test Relating to Dimensional Change>

Using the starting material for cutting according to Examples 21 to 24 and Examples 31 to 34, tests (1) and (2) relating to the dimensional change were performed in a similar manner as described above, and it was evaluated in a similar manner. As a result, similar evaluations as each of Examples 1 to 4 were obtained for Examples 21 to 24 and Examples 31 to 34.

### Examples 41 to 44

The same alloy material as in the aforementioned Example 1 was prepared. The alloy material was melted and the components were adjusted. Afterwards, using the alloy material, continuous casting was performed, in which almost all of the constitution is columnar crystals and/or granular crystals, and the irregularities in the grain size are unified, to obtain a cast bar having a diameter of 30 mm to 90 mm. Then, the cast bar was cut to obtain a cut article (see FIG. 2A). Afterward, using the cut article, in the same manner as in the aforementioned Examples 1 to 4, the starting material for cutting (secondary molded article) of Examples 41 to 44 were obtained (see FIG. 3B).

### Examples 51 to 54

Except that the same alloy material as in the aforementioned Example 11 was prepared, the starting material for cutting (secondary molded article) of Examples 51 to 54 were obtained in the same manner as in the aforementioned Examples 41 to 44.

### <Test Relating to Dimensional Change>

Using the starting material for cutting according to Examples 41 to 44 and Examples 51 to 54, tests (1) and (2) relating to the dimensional change were performed in the same manner as described above, and it was evaluated in the same manner. As a result, the same evaluations as in each of Examples 1 to 4 were obtained for Examples 41 to 44 and Examples 51 to 54.

The present invention claims priority to Japanese Patent Application No. 2013-140766 filed on Jul. 4, 2013, the entire disclosure of which is incorporated herein by reference in its entirety.

The terms and descriptions used herein are used only for explanatory purposes and the present invention is not limited to them. The present invention allows various design-changes falling within the claimed scope of the present invention unless it deviates from the spirits of the invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

### INDUSTRIAL APPLICABILITY

The method for producing a starting material for cutting of this invention can be used for producing a starting material for cutting which is a molded article before being subjected to a cutting process.

### DESCRIPTION OF SYMBOLS

1: primary molded article
11: large-diameter part
12: small-diameter part
2: secondary molded article
21: large-diameter part
22: small-diameter part
4: cut article (molding material)
5: cut/machined product
51: hub
52: blade
X: radial direction
Z: axial direction

1: A method for producing a starting material for cutting for producing a starting material for cutting to be cut into a cut/machined product, comprising:
a step for obtaining a primary molded article by subjecting a molding material to primary forming;
a step for subjecting the primary molded article to a solution treatment and then to a quenching treatment; and
a step for subjecting the primary molded article to secondary forming by cold forging after performing the quenching treatment to obtain a secondary molded article as a starting material for cutting,
wherein a shape of the primary molded article is determined in a manner as to eliminate residual stress accumulated in the primary molded article by the secondary forming.

2: The method for producing the starting material for cutting as recited in claim 1,
wherein, in the secondary forming, a processing rate of the primary molded article to the secondary molded article is set to be 2% to 5%.

3: The method for producing the starting material for cutting as recited in claim 1 or 2,
wherein cold forging is used for the primary forming.

4: The method for producing the starting material for cutting as recited in claim 1,
wherein hot forging is used for the primary forming.

5: The method for producing the starting material for cutting as recited in claim 1,
wherein the secondary molded article includes a first part and a second part arranged in an axial direction and having different dimensions in a radial direction orthogonal to the axial direction, and
wherein upset forging to compress in the axial direction is used as the secondary forming.

6: The method for producing the starting material for cutting as recited in claim 1,
wherein a shape of the secondary molded article is shaped so as to be capable of forming a compressor impeller having a hub and a plurality of blades formed radially on an outer peripheral surface of the hub by cutting.

7: The method for producing a cut/machined product, comprising:
a step for obtaining a starting material for cutting by the method for producing as recited in claim 1; and
a step for obtaining a cut/machined product by cutting the starting material for cutting.

8: The method for producing the cut/machined product as recited in the claim 7,
wherein a compressor impeller having a hub and a plurality of blades formed radially on the outer peripheral surface of the hub is obtained as a cut/machined product.

9: The method for producing the cut/machined product as recited in claim 8,
wherein, in the compressor impeller, an amount of positional displacement of a central axis between a top face and a bottom face is set to 0.01 mm or less.

10: The method for producing the cut/machined product as recited in claim 8,
wherein, in the compressor impeller, a ratio of the amount of positional displacement of a central axis between a top face and a bottom face with respect to a diameter of the bottom face is set to 0.013% or lower.

11: A starting material for cutting produced by the method for producing as recited in claim 1.
